(19) United States
(12) Patent Application Publication
(10) Pub. No.: US 2009/0327688 A1
(43) Pub. Date: Dec. 31, 2009

(54) METHOD AND SYSTEM FOR DETECTING A MALICIOUS CODE

(75) Inventors: Yichao Li, Shenzhen (CN); Lingzhi Gu, Shenzhen (CN); Yuqi Yang, Shenzhen (CN); Huan Du, Shenzhen (CN); Haowen Bai, Shenzhen (CN); Dan Liu, Shenzhen (CN); Yue Cao, Shenzhen (CN); Xiao Liang, Shenzhen (CN); Sheng Xu, Shenzhen (CN); Bocheng Shu, Shenzhen (CN); Fangming Chai, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: CHENGDU HUAWEI SYMANTEC TECHNOLOGIES CO., LTD., Chengdu (CN)

(21) Appl. No.: 12/483,681

(22) Filed: Jun. 12, 2009

(30) Foreign Application Priority Data
Jun. 28, 2008 (CN) 200810029174.5

(51) Int. Cl. G06F 21/00; G06F 9/00

(52) U.S. Cl. 713/100; 726/23; 719/328

(57) ABSTRACT

Embodiments of the present invention provide a method and a system for detecting a malicious code. The method includes obtaining first system information and second system information, and detecting the malicious code by identifying difference between the first system information and the second system information, which thus can detect an unknown malicious code, improve the system security, and can be easily implemented.

The application claims the benefit of priority to Chinese Patent Application No. 200810029174.5, filed on Jun. 28, 2008, and entitled “METHOD AND SYSTEM FOR DETECTING A MALICIOUS CODE”, which is incorporated herein by reference in its entirety.

### FIELD OF THE INVENTION

The present disclosure relates to the computer field, and more particularly to a method and a system for detecting a malicious code.

### BACKGROUND

With the popularity of the Internet, incidents threatening the information security occur more frequently, in which the harm caused by malicious code is the most serious, and thus the enterprises and users suffer from great economic losses, and the national information security is exposed to severe threats.

In the related art, a malicious code detection technique based on feature code scanning is provided, which is mainly adopted for commercially malicious code detection. The principle thereof is to open a file/memory to be detected and scan whether any malicious code feature string in a feature database is contained or not, and if yes, it is determined that the file/memory contains the malicious code. More and more malicious codes adopt a deformation technology, even for the known malicious codes, so that the malicious code detection technique based on the feature code scanning in the prior art cannot detect the unknown malicious code that does not exist in the feature database merely by scanning the file/memory.

### SUMMARY

In an embodiment of the present invention, a method for detecting a malicious code is provided, which includes the following blocks:

obtaining first system information and second system information in system information, wherein the first system information is obtained when a kernel code is running, and the second system information is obtained when a user code is running; and

detecting the malicious code by identifying difference between the first system information and the second system information.

Accordingly, in an embodiment of the present invention, a system for detecting a malicious code is provided. The system includes:

a system information collection module, adapted to obtain first system information and second system information in system information, wherein the first system information is obtained when a kernel code is running, and the second system information is obtained when a user code is running; and

a malicious behavior detection module, adapted to detect the malicious code by identifying difference between the first system information and the second system information.

Accordingly, in an embodiment of the present invention, a machine-readable storage is provided. A computer program stored in the machine-readable storage includes at least one code section for processing signals, the code section is executed by a machine, and the machine correspondingly executes the following blocks:

obtaining first system information and second system information in system information, wherein the first system information is obtained when a kernel code is running, and the second system information is obtained when a user code is running; and

detecting the malicious code by identifying difference between the first system information and the second system information.

### BRIEF DESCRIPTION OF THE DRAWINGS

In order to clearly illustrate the technical solutions in the embodiments of the present invention, the following accompanying drawings needed in the descriptions of the embodiments of the present invention are illustrated below briefly. Apparently, the following accompanying drawings are merely taken to illustrate some embodiments of the present invention, and ordinary people skilled in the art can derive other drawings based on the following drawings without creative work.

FIG. 1 is a main flow chart of a method for detecting a malicious code according to an embodiment of the present invention;

FIG. 2 is a specific flow chart of the method for detecting a malicious code according to an embodiment of the present invention;

FIG. 3 is a main structural view of a system for detecting a malicious code according to an embodiment of the present invention; and

FIG. 4 is a specific structural view of the system for detecting a malicious code according to an embodiment of the present invention.

### DETAILED DESCRIPTION

In embodiments of the present invention, a method and a system for detecting a malicious code are provided, which are capable of detecting a malicious code according to difference between first system information which is difficult to be modified by the malicious code and second system information which is easy to be modified by the malicious code, so as to detect an unknown malicious code, and improve system security.

When invading a system, a malicious code usually modifies certain system information that may indicate identity of the malicious code, and the system information generally includes process information, port information, file information, registry information, system service information, service provider interface (SPI) information, etc. The modification of the system information by the malicious code aims at providing untrue data to the detection software, so as to evade the detection. The system information may be divided into two types of system information, that is, the first system information which is difficult to be modified by the malicious code and the second system information which is easy to be modified by the malicious code.

The embodiments of the present invention are described below with reference to the accompanying drawings.

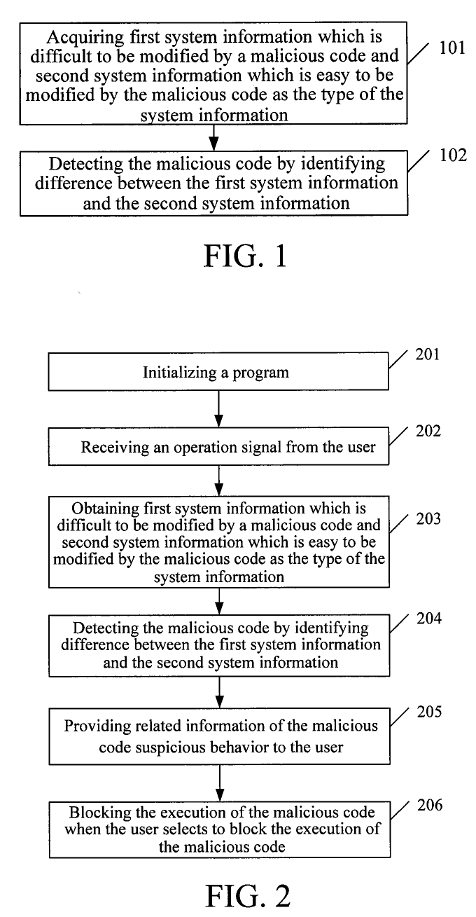

FIG. 1 is a main flow chart of a method for detecting a malicious code according to an embodiment of the present invention. Referring to FIG. 1, the method mainly includes the following processes.

In Block 101, the first system information which is difficult to be modified by a malicious code and second system information which is easy to be modified by the malicious code are obtained. Specifically, with reference to the above descriptions of types of the system information, the first system information which is difficult to be modified by the malicious code can be obtained from a system kernel mode, and the second system information which is easy to be modified by the malicious code corresponding to the first system information can be obtained from a system user mode. It should be noted that, a distinction between the system kernel mode and the system user mode is mainly based on a multi-user system. On a multi-user system, each user cannot interfere with each other, nor obtain confidential information from each other, and thus a protection mechanism is required. As the kernel code of the multi-user operating system is a running resource shared by all users, the kernel code of the multi-user operating system (including windows) must run at a high priority and in an environment with a maximum protection level. Thus, the codes that run in a machine are classified into two levels: a highly protected priority (kernel) and a general level (user program). When the CPU is running a kernel code, the system is in a kernel mode, and when the CPU is running a user code, the system is in a user mode.

In Block 102, the malicious code is detected by identifying difference between the first system information and the second system information.

FIG. 2 is a specific flow chart of the method for detecting a malicious code according to an embodiment of the present invention. The method is applicable to the Microsoft Windows operating system. Referring to FIG. 2, the method mainly includes the following blocks.

In Block 201, a program initialization is performed and all drive modules for collecting system information (including the first system information and the second system information) are installed.

In Block 202, an operation signal of a user is received, that is, the user can select to perform malicious code detection based on one or more of the following system information types: process information, port information, file information, registry information, system service information, SPI information, system service descriptor table (SSDT) information, global descriptor table (GDT) information, and interrupt descriptor table (IDT) information.

In Block 203, the first system information which is difficult to be modified by a malicious code and the second system information which is easy to be modified by the malicious code are obtained, which specifically includes the following situations.

A. When the System Information is Process Information

The obtaining the first system information which is difficult to be modified by the malicious code in the process information mainly includes: reading a global handle table of a system kernel mode in a driver, and determining whether a process handle in the global handle table is a valid handle or not, and if the process handle in the global handle table is a valid handle, taking process information corresponding to the process handle as the first system information. Specifically, by communicating with a driver by using a DeviceIoControl instruction, a global handle table PspCidTable is directly read from a system kernel mode in the driver, and then by adopting an exhaustive algorithm, it is determined whether each process handle that may exist in the global handle table has a valid process object or not. For example, as for each packet identifier (PID) that is a multiple of 4 among 0 to 0x43dc, an ExMapHandleToPointer instruction is invoked to map the handle to an object, and it is determined whether a response result of the ExMapHandleToPointer is null or not, and if response result of the ExMapHandleToPointer is not null, the process handle is determined to be a valid handle, and the process information corresponding to the process handle is taken as the first system information (which may serve as a certain entry of a first system information list).

The obtaining the second system information which is easy to be modified by the malicious code in the process information mainly includes: invoking a process tracking instruction of an application programming interface (API) of a system user mode, such as an EnumProcess enumeration instruction, and taking a response of the instruction as the second system information (which may serve as a certain entry of a second system information list).

B. When a Type of the System Information is the Port Information

The obtaining the first system information which is difficult to be modified by the malicious code in the port information mainly includes: creating and invoking a query instruction for a transmission control protocol (TCP) device port condition of a system kernel mode in a driver, and taking first TCP device port condition information responded by the instruction as the first system information. Specifically, by communicating with a driver by using a DeviceIoControl instruction, a ZwCreateFile instruction is invoked in the driver to open a TCP device object, an ObReferenceObjectByHandle instruction is invoked to obtain a TCP device object pointer, an IoBuildDeviceIoControlRequest instruction is invoked to create a TCP device port query request, i.e., input/output request packet (IRP), an IoSetCompletionRoutine instruction is invoked to set the routine, and finally, an IoCallDriver instruction is invoked to send the IRP, and the first TCP device port condition information responded by the IRP is taken as the first system information (which may serve as a certain entry of a first system information list).

The obtaining the second system information which is easy to be modified by the malicious code in the port information mainly includes: invoking an enumeration instruction for a TCP device port condition of an API of a system user mode, such as GetTcpTable instruction, and taking second TCP device port condition information responded by the instruction as the second system information (which may serve as a certain entry of a second system information list).

C. When a Type of the System Information is the File Information

The obtaining the first system information which is difficult to be modified by the malicious code in the file information mainly includes: creating and invoking a query instruction for file information in a designated path of a system kernel mode in a driver, and taking first file information responded by the instruction as the first system information. Specifically, the following operations are performed to the file information in a designated path: communicating with a driver by using a DeviceIoControl instruction, firstly invoking a ZwOpenFile instruction in the driver to obtain a file directory handle, invoking an ObReferenceObjectByHandle instruction to obtain a corresponding file object, and then allocating an IRP (i.e., a query instruction) by using an IoAllocateIrp instruction, and filling each IRP field to get ready to query the file directory, and finally, invoking an IoCallDriver instruction to send the IRP, and taking the first file information responded by the IRP as the first system information (which may serve as a certain entry of a first system information list). The first file information includes information of subdirectory, sub-file name, size, creation date, and modification date. Furthermore, all file information under the subdirectory is obtained till all files in the designated path have been queried.

The obtaining the second system information which is easy to be modified by the malicious code in the file information mainly includes: invoking a query instruction for file information in a designated path of an API of a system user mode, such as FindFirstFile instruction and FindNextFile instruction, and taking second file information responded by the instruction as the second system information (which may serve as a certain entry of a second system information list).

D. When a Type of the System Information is the Registry Information

As the registry information is required to be valid after the system is rebooted, all the registry information should be stored in a disk in the form of Hive file, and HKEY_LOCAL_MACHINE\SYSTEM\CurrentControlSet\Control\hivelist in the registry records a path for saving the system Hive files. Meanwhile, many functions of the system are realized depending upon the information provided by the files recorded in the system. Therefore, the system Hive files are safe, and the contents thereof are complete. The operating system generally does not allow other programs to access the Hive files in the system range. Thus, in order to obtain the first system information, the protection of the Hive files has to be evaded, so as to read the information therein.

The obtaining the first system information which is difficult to be modified by the malicious code in the registry information mainly includes: invoking a privilege granting instruction for the registry information of a system kernel mode, and taking first registry key value information in a designated path obtained according to the granted privilege as the first system information. Specifically, the following six instructions may be invoked to realize this block: invoking an RktRegInitialize instruction to complete an initialization of a registry detection module, which includes obtaining a Hive file reading privilege, saving the registry information as a Hive file, and determining positions of HKEY_CURRENT_USER and HKEY_CURRENT_ROOT in the Hive file; invoking an RktRegUninitialize instruction to release the resources and close the Hive file; invoking an RktRegOpenKey instruction to open a designated key in the Hive file; invoking an RktRegCloseKey instruction to close the designated key in the Hive file; invoking an RktRegEnumKey instruction to obtain all sub-keys of a certain opened key in the Hive file; and then invoking an RktRegEnumValue instruction to obtain all values of a certain opened key in the Hive file. Thus, once the Hive file reading privilege is obtained by invoking the RktRegInitialize instruction to complete the initialization of the registry detection module, the other instructions in the above six instructions may be invoked to obtain the first registry key value information in the designated path for serving as the first system information (which may serve as a certain entry of a first system information list).

The obtaining the second system information which is easy to be modified by the malicious code in the registry information mainly includes: invoking a registry operation instruction of an API of a system user mode, and taking the second registry key value information responded by the instruction as the second system information (which may serve as a certain entry of a second system information list).

E. When a Type of the System Information is the System Service Information

The obtaining the first system information which is difficult to be modified by the malicious code in the system service information mainly includes: invoking a privilege granting instruction for the registry information of a system kernel mode, and taking first system service information obtained according to the granted privilege as the first system information. Specifically, the system service information is saved in HKEY_LOCAL_MACHINE\system\CurrentControlSet\Services of the registry, and the obtaining the first system information further includes the following operations.

e1: An initialization is performed, and it is determined whether the RktRegInitialize instruction is invoked or not, and if the RktRegInitialize instruction is invoked, the process proceeds to e2 directly; otherwise, the RktRegInitialize instruction is invoked to perform the initialization, including obtaining the Hive file reading privilege, and saving the registry information as the Hive file.

e2: The Hive file where the current service exists is opened, and a service key is localized.

e3: The RktRegEnumKey instruction is invoked to enumerate all the sub-keys, and if any sub-key that is not enumerated yet exists, the process proceeds to e4.

e4: The RktRegOpenKey instruction is invoked to open the sub-key, and the RktRegEnumValue instruction is invoked to read the data of the service related value, and then it is determined whether the sub-key is the first system service information or not, and if the sub-key is the first system service information, the first system service information is taken as the first system information (which may serve as a certain entry of a first system information list), and the process proceeds to e3; otherwise, the process proceeds to e3 directly.

The obtaining the second system information which is easy to be modified by the malicious code in the system service information mainly includes: invoking a registry operation instruction of an API of a system user mode for obtaining the system service information, and taking second system service information responded by the instruction as the second system information (which may serve as a certain entry of a second system information list).

F. When a Type of the System Information is the SPI Information

The obtaining the first system information which is difficult to be modified by the malicious code in the SPI information mainly includes: invoking a privilege granting instruction for the registry information of a system kernel mode, and taking second SPI information obtained according to the granted privilege as the first system information (which may serve as a certain entry of a first system information list).

Specifically, all dynamic link library (DLL) paths of the SPI are saved in HKEY_LOCAL_MACHINE\system\CurrentControlSet\Services\WinSock2\Parameters\Protocol\Catalog9\Catalog_Entries of the registry, and the obtaining the first system information further includes the following operations.

f1: An initialization is performed, and it is determined whether the RktRegInitialize instruction is invoked or not, and if the RktRegInitialize instruction is invoked, the process proceeds to f2 directly; otherwise, the RktRegInitialize instruction is invoked to perform the initialization, including obtaining the Hive file reading privilege, and saving the registry information as a Hive file.

f2: The Hive file where the current service exists is opened, a service key is localized, and the key where the SPI exists is opened.

f3: If all sub-keys have been enumerated by using the RktRegEnumKey instruction, the RktRegEnumKey instruction is invoked to enumerate all the sub-keys, and if any sub-key that is not enumerated yet exists, the process proceeds to f4.

f4: The RktRegOpenKey instruction is invoked to open the sub-key, the RktRegEnumValue instruction is invoked to read the SPI data, and the process proceeds to f3.

The obtaining the second system information which is easy to be modified by the malicious code in the SPI information mainly includes: invoking a registry operation instruction of an API of a system user mode for obtaining the SPI information, and taking second SPI information responded by the instruction as the second system information (which may serve as a certain entry of a second system information list).

Furthermore, Block 203 may further include obtaining system service descriptor table (SSDT) information, global descriptor table (GDT) information, or interrupt descriptor table (IDT) information, which serve as the reference information provided for users (such as advanced users) during the malicious code detection. The obtaining the SSDT information/GDT information/IDT information further includes the following processes.

An SSDT obtainment instruction of the system kernel mode, such as KeServiceDescriptorTable instruction, is invoked to obtain the SSDT information.

A GDT obtainment instruction of the system kernel mode, such as sgdt instruction, is invoked, and related items are replicated, so as to obtain the GDT information.

An IDT obtainment instruction of the system kernel mode, such as sidt instruction, is invoked, and related items are replicated, so as to obtain the IDT information.

In Block 204, the malicious code is detected by identifying difference between the first system information and the second system information. Specifically, if a type of the system information is the process information, it is compared whether the first process information (or list, the same below) as the first system information is consistent with the second process information (or list, the same below) as the second system information; if a type of the system information is the port information, it is compared whether the first port information as the first system information is consistent with the second port information as the second system information; if a type of the system information is the file information, it is compared whether the first file information (file directory name, file name, etc.) as the first system information is consistent with the second file information as the second system information; if a type of the system information is the registry information, it is compared whether the first registry key value information as the first system information is consistent with the second registry key value information as the second system information; if a type of the system information is the system service information, it is compared whether the first system service information as the first system information is consistent with the second system service information as the second system information; if a type of the system information is the SPI information, it is compared whether the first SPI information as the first system information is consistent with the second SPI information as the second system information. If certain difference is determined to exist between the first system information and the second system information by comparing, the malicious code is detected, so that the difference between the first system information and the second system information is taken as a malicious code suspicious behavior.

Furthermore, when no difference exists between the first system information and the second system information, the first system information and the second system information may be released to save storage space.

In Block 205, related information of the malicious code suspicious behavior is provided for the user, and the user is inquired whether to ignore or block the execution of the malicious code.

In Block 206, the execution of the malicious code is blocked when the user selects to block the execution of the malicious code, and related information, such as detection process, detection result, and detection time may be recorded into a log.

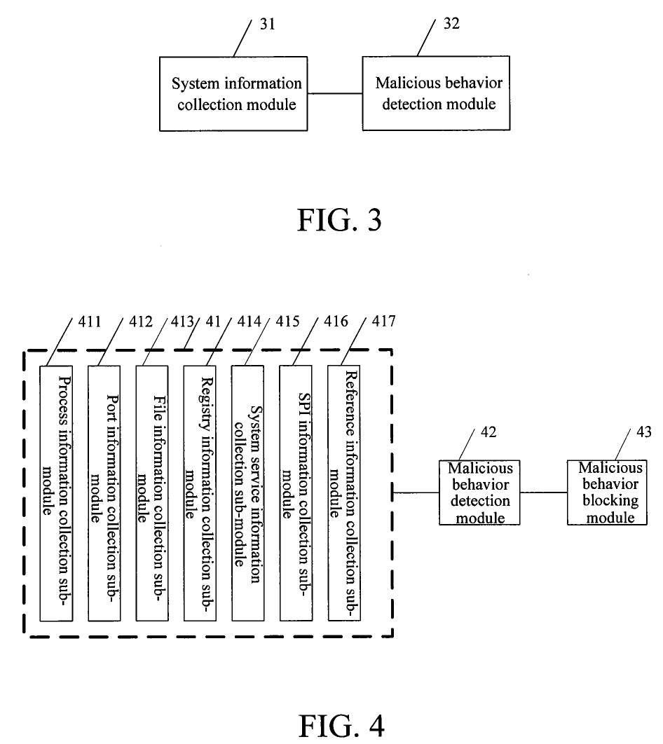

FIG. 3 is a main structural view of a system for detecting a malicious code according to an embodiment of the present invention. Referring to FIG. 3, the system mainly includes a system information collection module 31 and a malicious behavior detection module 32.

The system information collection module 31 is adapted to obtain first system information which is difficult to be modified by a malicious code and second system information which is easy to be modified by the malicious code. Specifically, the first system information which is difficult to be modified by the malicious code may be obtained from a system kernel mode, and the second system information which is easy to be modified by the malicious code corresponding to the first system information may be obtained from a system user mode. The system information may be one or any combination of: process information, port information, file information, registry information, system service information, and SPI information.

The malicious behavior detection module 32 is adapted to detect the malicious code by identifying difference between the first system information and the second system information.

FIG. 4 is a specific structural view of the system for detecting a malicious code according to the embodiment of the present invention. The system is applicable to the Microsoft Windows operating system. Referring to FIG. 4, the system includes a system information collection module 41, a malicious behavior detection module 42, and a malicious behavior blocking module 43.

The system information collection module 41 is adapted to obtain first system information which is difficult to be modified by a malicious code and second system information which is easy to be modified by the malicious code. Specifically, the system information collection module 41 may include one or a combination of the following sub-modules, including a process information collection sub-module 411, a port information collection sub-module 412, a file information collection sub-module 413, a registry information collection sub-module 414, a system service information collection sub-module 415, and an SPI information collection sub-module 416.

The process information collection sub-module 411 is adapted to obtain the first system information which is difficult to be modified by the malicious code and the second system information which is easy to be modified by the malicious code in the process information.

In order to obtain the first system information which is difficult to be modified by the malicious code in the process information, the process information collection sub-module 411 reads a global handle table of a system kernel mode in a driver, and determines whether a process handle in the global handle table is a valid handle or not, and if the process handle in the global handle table is the valid handle, takes process information corresponding to the process handle as the first system information. Specifically, by communicating with the driver by using a DeviceIoControl instruction, a global handle table PspCidTable is directly read from a system kernel mode in the driver, and then by adopting an exhaustive algorithm, it is determined whether each process handle that may exist in the global handle table has a valid process object or not. For example, as for each PID that is a multiple of 4 among 0 to 0x43dc, an ExMapHandleToPointer instruction is invoked to map the handle to an object, and it is determined whether a response result of the ExMapHandleToPointer instruction is null or not, and if response result of the ExMapHandleToPointer instruction is not null, the process handle is determined to be the valid handle, and the process information corresponding to the process handle is taken as the first system information (which may serve as a certain entry of a first system information list).

In order to obtain the second system information which is easy to be modified by the malicious code in the process information, the process information collection sub-module 411 invokes a process tracking instruction of an API of a system user mode, such as an EnumProcess instruction, and takes a response of the instruction as the second system information (which may serve as a certain entry of a second system information list).

The port information collection sub-module 412 is adapted to obtain the first system information which is difficult to be modified by the malicious code and the second system information which is easy to be modified by the malicious code in the port information.

In order to obtain the first system information which is difficult to be modified by the malicious code in the port information, the port information collection sub-module 412 creates and invokes a query instruction for a TCP device port condition of a system kernel mode in a driver, and takes first TCP device port condition information responded by the instruction as the first system information. Specifically, by communicating with a driver by using a DeviceIoControl instruction, a ZwCreateFile instruction is invoked in the driver to open a TCP device object, an ObReferenceObjectByHandle instruction is invoked to obtain a TCP device object pointer, an IoBuildDeviceIoControlRequest instruction is invoked to create a TCP device port query request, i.e., IRP, an IoSetCompletionRoutine instruction is invoked to set the routine, and finally, an IoCallDriver instruction is invoked to send the IRP, and the first TCP device port condition information responded by the IRP is taken as the first system information (which may serve as a certain entry of a first system information list).

In order to obtain the second system information which is easy to be modified by the malicious code in the port information, the port information collection sub-module 412 invokes an enumeration instruction for a TCP device port condition of an API of a system user mode, such as GetTcpTable instruction, and takes second TCP device port condition information responded by the instruction as the second system information (which may serve as a certain entry of a second system information list).

The file information collection sub-module 413 is adapted to obtain the first system information which is difficult to be modified by the malicious code and the second system information which is easy to be modified by the malicious code in the file information.

In order to obtain the first system information which is difficult to be modified by the malicious code in the file information, the file information collection sub-module 413 creates and invokes a query instruction for file information in a designated path of a system kernel mode in a driver, and takes first file information responded by the instruction as the first system information. Specifically, the following operations are performed to the file information in a designated path: communicating with a driver by using a DeviceIoControl instruction, firstly invoking a ZwOpenFile instruction in the driver to obtain a file directory handle, invoking an ObReferenceObjectByHandle instruction to obtain a corresponding file object, and then allocating an IRP (i.e., a query instruction) by using an IoAllocateIrp instruction, and filling each IRP field to get ready to query the file directory, and finally invoking an IoCallDriver instruction to send the IRP, and taking the first file information responded by the IRP as the first system information (which may serve as a certain entry of a first system information list). The first file information includes information of subdirectory, sub-file name, size, creation date, and modification date. Furthermore, all file information under the subdirectory is obtained till all files in the designated path have been queried.

In order to obtain the second system information which is easy to be modified by the malicious code in the file information, the file information collection sub-module 413 invokes a query instruction for file information in a designated path of an API of a system user mode, such as FindFirstFile instruction and FindNextFile instruction, and takes second file information responded by the instruction as the second system information (which may serve as a certain entry of a second system information list).

The registry information collection sub-module 414 is adapted to obtain the first system information which is difficult to be modified by the malicious code and the second system information which is easy to be modified by the malicious code in the registry information.

As the registry information is required to be valid after the system is rebooted, all the registry information should be stored in a disk in the form of Hive file, and HKEY_LOCAL_MACHINE\SYSTEM\CurrentControlSet\Control\hivelist in the registry records a path for saving the system Hive files. Meanwhile, many functions of the system are realized depending upon the information provided by the files recorded in the system. Therefore, the system Hive files are safe, and the contents thereof are complete. The operating system generally does not allow other programs to access the Hive files in the system range. Thus, in order to obtain the first system information, the protection of the Hive files has to be evaded, so as to read the information therein.

In order to obtain the first system information which is difficult to be modified by the malicious code in the registry information, the registry information collection sub-module 414 invokes a privilege granting instruction for registry information of a system kernel mode, and takes first registry key value information in a designated path obtained according to the granted privilege as the first system information. Specifically, the following six instructions may be invoked to complete the function of the registry information collection sub-module 414: invoking an RktRegInitialize instruction to complete an initialization of a registry detection module, which includes obtaining a Hive file reading privilege, saving the registry information as a Hive file, and determining positions of HKEY_CURRENT_USER and HKEY_CURRENT_ROOT in the Hive file; invoking an RktRegUninitialize instruction to release the resources and close the Hive file; invoking an RktRegOpenKey instruction to open a designated key in the Hive file; invoking an RktRegCloseKey instruction to close the designated key in the Hive file; invoking an RktRegEnumKey instruction to obtain all sub-keys of a certain opened key in the Hive file; and then invoking a RktRegEnumValue instruction to obtain all values of a certain opened key in the Hive file. Thus, once the Hive file reading privilege is obtained by invoking the RktRegInitialize instruction to complete the initialization of the registry detection module, the other instructions in the above six instructions may be invoked to obtain the first registry key value information in the designated path for serving as the first system information (which may serve as a certain entry of a first system information list).

In order to obtain the second system information which is easy to be modified by the malicious code in the registry information, the registry information collection sub-module 414 invokes a registry operation instruction of an API of a system user mode, and takes second registry key value information responded by the instruction as the second system information (which may serve as a certain entry of a second system information list).

The system service information collection sub-module 415 is adapted to obtain the first system information which is difficult to be modified by the malicious code and the second system information which is easy to be modified by the malicious code in the system service information.

In order to obtain the first system information which is difficult to be modified by the malicious code in the system service information, the system service information collection sub-module 415 invokes a privilege granting instruction for the registry information of a system kernel mode, and takes first system service information obtained according to the granted privilege as the first system information. Specifically, the system service information is saved in the HKEY_LOCAL_MACHINE\system\CurrentControlSet\Services of the registry. Firstly, an initialization is performed, and it is determined whether the RktRegInitialize instruction is invoked or not, in which if the RktRegInitialize instruction is invoked, the Hive file where the current service exists is directly opened and a service key is localized; otherwise, the RktRegInitialize instruction is invoked to perform the initialization, including obtaining the Hive file reading privilege and saving the registry information as the Hive file, and then the Hive file where the current service exists is opened, and the service key is localized. If all sub-keys have been enumerated by using the RktRegEnumKey instruction, the RktRegEnumKey instruction is invoked to enumerate all the sub-keys. If any sub-key that is not enumerated yet exists, the RktRegOpenKey instruction is invoked to open the sub-key, and the RktRegEnumValue instruction is invoked to read the data of the service related value, and then it is determined whether the sub-key is the first system service information or not, and if the sub-key is the first system service information, the first system service information is taken as the first system information (which may serve as an entry of a first system information list).

In order to obtain the second system information which is easy to be modified by the malicious code in the system service information, the system service information collection sub-module 415 invokes a registry operation instruction of an API of a system user mode for obtaining the system service information, and takes second system service information responded by the instruction as the second system information (which may serve as an entry of a second system information list).

The SPI information collection sub-module 416 is adapted to obtain the first system information which is difficult to be modified by the malicious code and the second system information which is easy to be modified by the malicious code in the SPI information.

In order to obtain the first system information which is difficult to be modified by the malicious code in the SPI information, the SPI information collection sub-module 416 invokes a privilege granting instruction for the registry information of a system kernel mode, and takes first SPI information obtained according to the granted privilege as the first system information (which may serve as an entry of a first system information list). Specifically, all the DLL paths of the SPI are stored in the HKEY_LOCAL_MACHINE\system\CurrentControlSet\Services\WinSock2\Parameters\Protocol_Catalog9\Catalog_Entries. First, an initialization is performed, and it is determined whether the RktRegInitialize instruction is invoked or not, in which if the RktRegInitialize instruction is invoked, the Hive file where the current service exists is opened, a service key is localized, and the key where the SPI exists is opened; otherwise, the RktRegInitialize instruction is invoked to perform the initialization, including obtaining the Hive file reading privilege and saving the registry information as the Hive file, and then, the Hive file where the current service exists is opened, the service key is localized, and the key where the SPI exists is opened. If all sub-keys have been enumerated by using the RktRegEnumKey instruction, the RktRegEnumKey instruction is invoked to enumerate all the sub-keys. If any sub-key that is not enumerated yet exists, the RktRegOpenKey is invoked to open the sub-key, and the RktRegEnumValue instruction is invoked to read the SPI data.

In order to obtain the second system information which is easy to be modified by the malicious code in the SPI information, the SPI information collection sub-module 416 invokes a registry operation instruction of an API of a system user mode for obtaining the SPI information, and takes second SPI information responded by the instruction as the second system information (which may serve as an entry of a second system information list).

Furthermore, the system information collection module 41 may further include a reference information collection sub-module 417.

The reference information collection sub-module 417 is adapted to obtain SSDT information, GDT information, or IDT information, which serves as the reference information provided for users (such as advanced users) when performing the malicious code detection. Specifically, an SSDT obtainment instruction of the system kernel mode, such as KeServiceDescriptorTable instruction, is invoked to obtain the SSDT information; a GDT obtainment instruction of the system kernel mode, such as sgdt instruction, is invoked, and related items are replicated to obtain the GDT information; or an IDT obtainment instruction of the system kernel mode, such as, sidt instruction, is invoked, and related items are replicated to obtain the IDT information.

The malicious behavior detection module 42 is adapted to detect the malicious code by identifying difference between the first system information and the second system information. Specifically, if a type of the system information is the process information, it is compared whether the first process information (or list, the same below) as the first system information is consistent with the second process information (or list, the same below) as the second system information; if a type of the system information is the port information, it is compared whether the first port information as the first system information is consistent with the second port information as the second system information; if a type of the system information is the file information, it is compared whether the first file information (file directory name, file name, etc.) as the first system information is consistent with the second file information as the second system information; if a type of the system information is the registry information, it is compared whether the first registry key value information as the first system information is consistent with the second registry key value information as the second system information; if a type of the system information is the system service information, it is compared whether the first system service information as the first system information is consistent with the second system service information as the second system information; if a type of the system information is the SPI information, it is compared whether the first SPI information as the first system information is consistent with the second SPI information as the second system information. If certain difference is determined to exist between the first system information and the second system information by comparing, the difference between the first system information and the second system information is taken as a malicious code suspicious behavior.

The malicious behavior blocking module 43 is adapted to provide related information of the malicious code suspicious behavior to the user, and inquire the user whether to ignore or block the execution of the malicious code. The malicious behavior blocking module 43 blocks the execution of the malicious code if the user selects to block the execution of the malicious code, and records related information, such as detection process, detection result, and detection time into a log.

Through the above embodiments of the present invention, the first system information which is difficult to be modified by the malicious code and the second system information which is easy to be modified by the malicious code are obtained, and difference between the first system information and the second system information is identified, which is taken as the malicious code suspicious behavior, and thus, all kinds of hidden malicious codes can be effectively detected. The detection operation aims at detecting the malicious code suspicious behavior, instead of the malicious code itself. Thus, regardless of the deformation of the malicious code, it can be detected from the system information, and thus the system security can be improved.

Furthermore, those of ordinary skill in the art may appreciate that, all or a part of the processes of the method in the above embodiments may be finished by relevant hardware instructed by a program, and the program may be stored in a computer-readable storage medium. When the program is executed, the process of the method in the embodiments is performed. The storage medium includes a magnetic disk, an optical disk, a read only memory (ROM), or a random access memory (RAM).

It will be apparent to those skilled in the art that various modifications and variations can be made to the present invention without departing from the scope of the invention. In view of the foregoing, it is intended that the present invention cover modifications and variations of this invention provided that they fall within the scope of the following claims and their equivalents.

1. A method for detecting a malicious code, comprising:
obtaining first system information and second system information in system information, wherein the first system information is obtained when a kernel code is running, and the second system information is obtained when a user code is running; and
detecting the malicious code by identifying difference between the first system information and the second system information.

2. The method according to claim 1, wherein the first system information is difficult to be modified by the malicious code, and the second system information is easy to be modified by the malicious code.

3. The method according to claim 1, wherein the system information comprises one or any combination of: process information, port information, file information, registry information, system service information, and service provider interface (SPI) information.

4. The method according to claim 3, wherein obtaining the first system information and the second system information comprises:
when a type of the system information is the process information, reading a global handle table in a system kernel mode in a driver, and determining whether a process handle in the global handle table is a valid handle or not, and if the process handle in the global handle table is a valid handle, taking first process information corresponding to the process handle as the first system information; invoking a process tracking instruction of an application programming interface (API) of a system user mode, and taking second process information responded by the instruction as the second system information;
when a type of the system information is the port information, creating and invoking a query instruction for a transmission control protocol (TCP) device port condition of a system kernel mode in a driver, and taking first TCP device port condition information responded by the instruction as the first system information; invoking an enumeration instruction for a TCP device port condition of an API of a system user mode, and taking second TCP device port condition information responded by the instruction as the second system information; or
when a type of the system information is the file information, creating and invoking a query instruction for file information in a designated path of a system kernel mode in a driver, and taking first file information responded by the instruction as the first system information; invoking a query instruction for file information in a designated path of an API of a system user mode, and taking second file information responded by the instruction as the second system information.

5. The method according to claim 3, wherein obtaining the first system information and the second system information further comprises:
when a type of the system information is the registry information, invoking a privilege granting instruction for registry information of a system kernel mode, and taking first registry key value information in a designated path obtained according to a granted privilege as the first system information; invoking a registry operation instruction of an API of a system user mode, and taking second registry key value information responded by the instruction as the second system information;
when a type of the system information is the system service information, invoking a privilege granting instruction for registry information of a system kernel mode, and taking first system service information obtained according to a granted privilege as the first system information; invoking a registry operation instruction of an API of a system user mode for obtaining system service information, and taking second system service information responded by the instruction as the second system information; or
when a type of the system information is the SPI information, invoking a privilege granting instruction for registry information of a system kernel mode, and taking first SPI information obtained according to a granted privilege as the first system information; invoking a registry operation instruction of an API of a system user mode for obtaining SPI information, and taking second SPI information responded by the instruction as the second system information.

6. The method according to claim 1, further comprising:
obtaining system service descriptor table (SSDT) information, global descriptor table (GDT) information, or interrupt descriptor table (IDT) information to serve as reference information provided for a user during malicious code detection.

7. The method according to claim 1, further comprising:
blocking execution of the malicious code and/or recording related information.

8. A system for detecting a malicious code, comprising:
a system information collection module, adapted to obtain first system information and second system information in system information, wherein the first system information is obtained when a kernel code is running, and the second system information is obtained when a user code is running; and
a malicious behavior detection module, adapted to detect the malicious code by identifying difference between the first system information and the second system information.

9. The system according to claim 8, wherein the first system information is difficult to be
modified by the malicious code, and the second system information is easy to be modified by the malicious code.

10. The system according to claim 8, wherein the system information comprises one or any combination of: process information, port information, file information, registry information, system service information, and service provider interface (SPI) information.

11. The system according to claim 10, wherein the system information collection module comprises one or any combination of the following modules:
a process information collection sub-module, when a type of the system information is the process information, adapted to read a global handle table of a system kernel mode in a driver, determine whether a process handle in the global handle table is a valid handle or not, take first process information corresponding to the process handle as the first system information if the process handle in the global handle table is the valid handle, invoke a process tracking instruction of an application programming interface (API) of a system user mode, and take second process information responded by the instruction as the second system information;
a port information collection sub-module, when a type of the system information is the port information, adapted to create and invoke a query instruction for a transmission control protocol (TCP) device port condition of a system kernel mode in a driver, take first TCP device port condition information responded by the instruction as the first system information, invoke an enumeration instruction for a TCP device port condition of an API of a system user mode, and take second TCP device port condition information responded by the instruction as the second system information;
a file information collection sub-module, when a type of the system information is the file information, adapted to create and invoke a query instruction for file information in a designated path of a system kernel mode in a driver, take first file information responded by the instruction as the first system information, invoke a query instruction for file information in a designated path of an API of a system user mode, and take second file information responded by the instruction as the second system information;
a registry information collection sub-module, when a type of the system information is the registry information, adapted to invoke a privilege granting instruction for registry information of a system kernel mode, take first registry key value information in a designated path obtained according to a granted privilege as the first system information, invoke a registry operation instruction of an API of a system user mode, and take second registry key value information responded by the instruction as the second system information;
a system service information collection sub-module, when a type of the system information is the system service information, adapted to invoke a privilege granting instruction for registry information of a system kernel mode, take first system service information obtained according to a granted privilege as the first system information, invoke a registry operation instruction of an API of a system user mode for obtaining system service information, and take second system service information responded by the instruction as the second system information; and
an SPI information collection sub-module, when a type of the system information is the SPI information, adapted to invoke a privilege granting instruction for registry information of a system kernel mode, take first SPI information obtained according to a granted privilege as the first system information, invoke a registry operation instruction of an API of a system user mode for obtaining SPI information, and take second SPI information responded by the instruction as the second system information.

12. The system according to claim 8, wherein the system information collection module further comprises:
a reference information collection sub-module, adapted to obtain system service descriptor table (SSDT) information, global descriptor table (GDT) information, or interrupt descriptor table (IDT) information to serve as reference information provided for a user during malicious code detection.

13. The system according to claim 8, further comprising:
a malicious behavior blocking module, adapted to block execution of the malicious code and/or record related information.

14. A machine-readable storage, wherein a computer program stored therein comprises at least one code section adapted to process signals, the code section is executed by a machine, comprising:
obtaining first system information and second system information in system information, wherein the first system information is obtained when a kernel code is running, and the second system information is obtained when a user code is running; and
detecting the malicious code by identifying difference between the first system information and the second system information.

15. The machine-readable storage according to claim 14, wherein the first system information is difficult to be modified by the malicious code, and the second system information is easy to be modified by the malicious code.

16. The machine-readable storage according to claim 14, wherein the system information comprises one or any combination of: process information, port information, file information, registry information, system service information, and service provider interface (SPI) information.

17. The machine-readable storage according to claim 16, wherein the obtaining the first system information and the second system information comprises:
when a type of the system information is the process information, reading a global handle table in a system kernel mode in a driver, and determining whether a process handle in the global handle table is a valid handle or not, and if the process handle in the global handle table is the valid handle, taking first process information corresponding to the process handle as the first system information; invoking a process tracking instruction of an application programming interface (API) of a system user mode, and taking second process information responded by the instruction as the second system information;
when a type of the system information is the port information, creating and invoking a query instruction for a transmission control protocol (TCP) device port condition of a system kernel mode in a driver, and taking first TCP device port condition information responded by the instruction as the first system information; invoking an enumeration instruction for a TCP device port condition of an API of a system user mode, and taking second TCP device port condition information responded by the instruction as the second system information; or
when a type of the system information is the file information, creating and invoking a query instruction for file information in a designated path of a system kernel mode in a driver, and taking first file information responded by the instruction as the first system information; invoking a query instruction for file information in a designated path of an API of a system user mode, and taking second file information responded by the instruction as the second system information.

18. The machine-readable storage according to claim 16, wherein obtaining the first system information and the second system information further comprises:
when a type of the system information is the registry information, invoking a privilege granting instruction for registry information of a system kernel mode, and taking first registry key value information in a designated path obtained according to a granted privilege as the first system information; invoking a registry operation instruction of an API of a system user mode, and taking second registry key value information responded by the instruction as the second system information;
when a type of the system information is the system service information, invoking a privilege granting instruction for registry information of a system kernel mode, and taking first system service information obtained according to a granted privilege as the first system information; invoking a registry operation instruction of an API of a system user mode for obtaining system service information, and taking second system service information responded by the instruction as the second system information; or
when a type of the system information is the SPI information, invoking a privilege granting instruction for registry information of a system kernel mode, and taking first SPI information obtained according to a granted privilege as the first system information; invoking a registry operation instruction of an API of a system user mode for obtaining SPI information, and taking second SPI information responded by the instruction as the second system information.
